(19) United States
(12) Patent Application Publication
(10) Pub. No.: US 2017/0155614 A1
(43) Pub. Date: Jun. 1, 2017

(54) OPPORTUNISTIC COMPUTATION OF RUNNING PATHS TO ENCOURAGE FRIEND ENCOUNTERS

(71) Applicant: International Business Machines Corporation, Armonk, NY (US)

(72) Inventors: David M. Lubensky, Brookfield, CT (US); Justin D. Weisz, Stamford, CT (US)

(21) Appl. No.: 14/955,502

(22) Filed: Dec. 1, 2015

(51) Int. Cl. H04L 12/58; H04L 29/08

(52) U.S. Cl. CPC H04L 51/32; H04L 67/18; H04L 67/22; H04L 67/10

(57) ABSTRACT

Embodiments include methods, systems and computer program products for providing information to two or more people who know each other and who are running separately yet relatively near to each other at the same instance in time to come together and thereafter run together are provided. Aspects include determining a movement state and a location of a first user, and determining a movement state and a location of at least one other user. Aspects also include based on the location of the first user and the location of the at least one other user being within a predetermined distance from one another, determining a route for each of the first user and the at least one other user to travel to come together at a single geographic location.

### BACKGROUND

The present invention relates to social networks, and more specifically, to methods, systems and computer program products for providing information to two or more people who know each other and who are running separately yet relatively near to each other at the same instance in time to come together and thereafter run together.

Recently, social networks have become an increasingly popular way for people to communicate with each other directly or indirectly in various different scenarios. One type of scenario is when a number of people share the same interest during their leisure time when they are not working. One such shared interest is a physical activity or exercise such as running or jogging. Oftentimes, two or more people who are friends get together ahead of time and plan a day and time to run together from a certain starting location.

However, what is needed is a better way for one or more runners who know each other and who are running separately yet relatively near each other at the same instance in time and without either person having knowledge of the other runner's current location to be directed to a certain location where they can meet up and continue to run together thereafter.

### SUMMARY

According to an embodiment of the present invention, a method is provided. The method includes determining a movement state and a location of a first user, and determining a movement state and a location of at least one other user. The method also includes based on the location of the first user and the location of the at least one other user being within a predetermined distance from one another, determining a route for each of the first user and the at least one other user to travel to come together at a single geographic location.

According to another embodiment of the present invention, a system has a processor in communication with one or more types of memory. The processor is configured to determine a movement state and a location of a first user, and to determine a movement state and a location of at least one other user. The processor is also configured to based on the location of the first user and the location of the at least one other user being within a predetermined distance from one another, determine a route for each of the first user and the at least one other user to travel to come together at a single geographic location.

According to yet another embodiment of the present invention, a computer program product includes a non-transitory storage medium readable by a processing circuit and storing instructions for execution by the processing circuit for performing a method. The method includes determining a movement state and a location of a first user, and determining a movement state and a location of at least one other user. The method also includes based on the location of the first user and the location of the at least one other user being within a predetermined distance from one another, determining a route for each of the first user and the at least one other user to travel to come together at a single geographic location.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a cloud computing environment according to an embodiment of the present invention;

FIG. 2 depicts abstraction model layers according to an embodiment of the present invention;

FIG. 3 is a block diagram illustrating one example of a processing system for practice of the teachings herein;

FIG. 4 is a block diagram showing a social network utilized to encourage two or more persons who know each other and who are both engaging in the same activity at the same time to have their current geographical location determined and then the two ore more persons are directed toward each other such that they eventually meet up, in accordance with an embodiment of the present invention; and

FIG. 5 is a flow diagram of a method for implementing a social network that implements the social running service and the social networking service in accordance with embodiments of the present invention.

### DETAILED DESCRIPTION

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

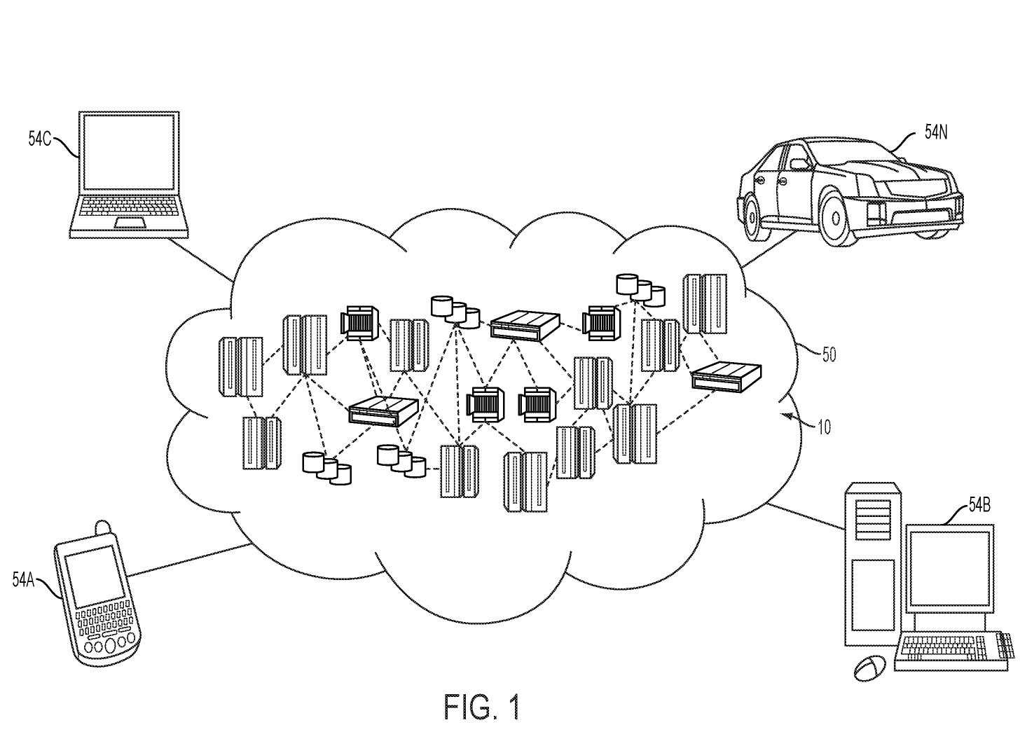

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

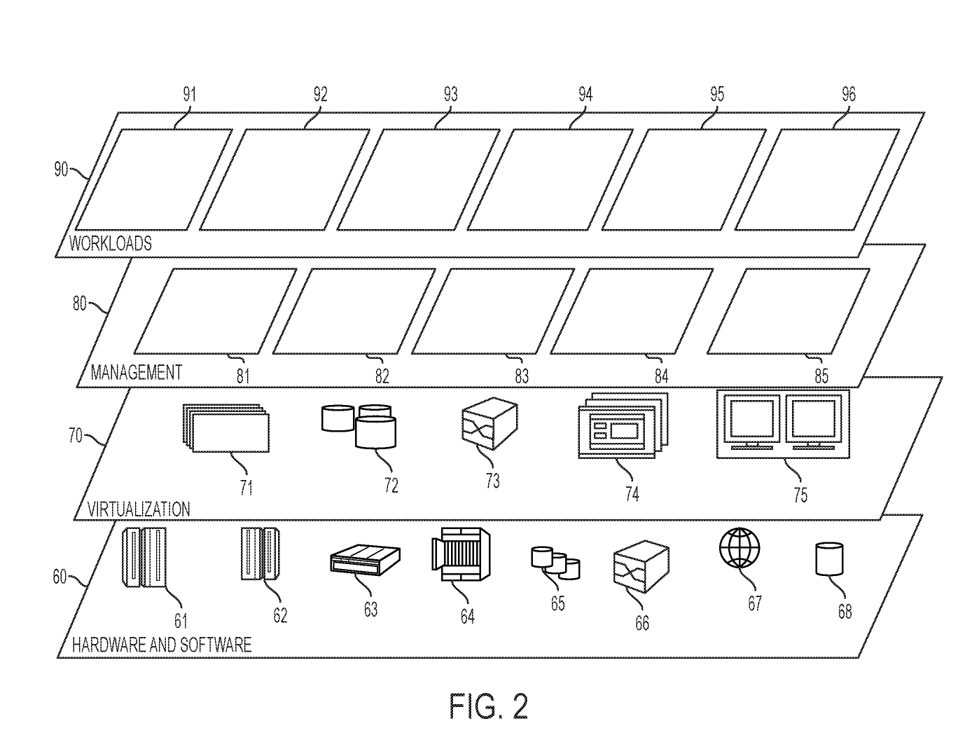

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and for providing information to two or more people who know each other and who are running separately yet relatively near to each other at the same instance in time to come together and thereafter run together 96.

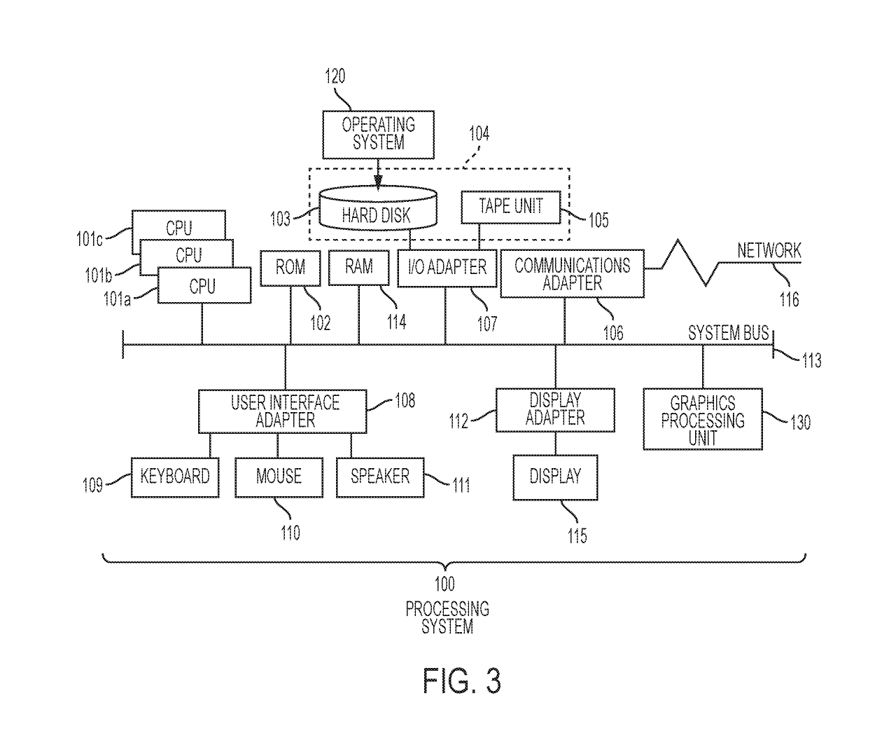

Referring to FIG. 3, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 3 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing, and has a highly parallel structure that makes it more effective than general-purpose CPUs for algorithms where processing of large blocks of data is done in parallel.

Thus, as configured in FIG. 3, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system to coordinate the functions of the various components shown in FIG. 3.

In accordance with exemplary embodiments of the disclosure, methods, systems and computer program products for providing information to two or more people who know each other and who are running separately yet relatively near to each other at the same instance in time to come together and thereafter run together are provided.

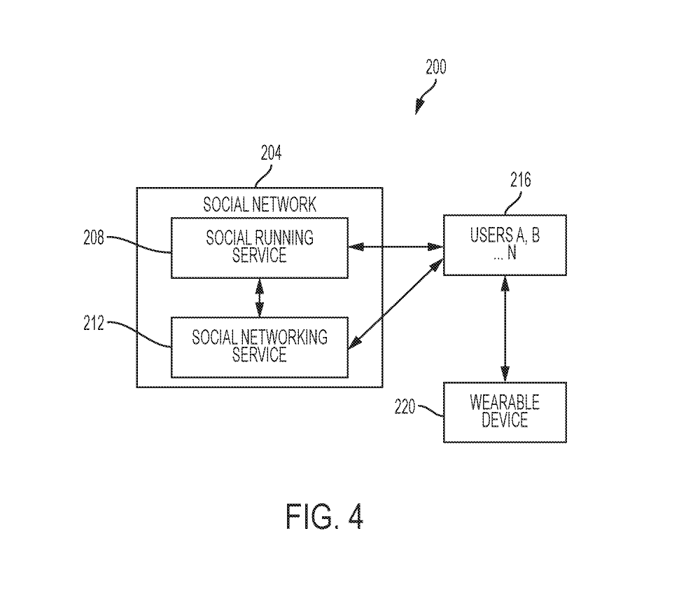

Referring to FIG. 4, there illustrated is a block diagram of an embodiment of the present invention of a system 200 in which a social network 204 is utilized with two or more persons or users who know each other and who are both engaging in the same activity (e.g., running) at the same time to have their current geographical positions or locations determined. The two or more persons are then directed to run toward each other to a common geographical location such that they eventually meet up and, if desired, can continue to run together.

The social network 204 may comprise a social running service 208 and a social networking service 212. Both services 208, 212 may be implemented in the same social network 204 and by the same processor or by separate processors—one processor for the social running service 208 and another processor for the social networking service 212. Further, both services 208, 212, may be implemented in the cloud (FIGS. 1-2) or by the processing system 100 (FIG. 3), or some combination of the services 208, 212 may be implemented in the cloud and the processing system 100, including memory. Still further, both services 208, 212 may comprise the same service (i.e., the social running service 208 and the social networking service 212 may comprise the same service having the somewhat different functionalities of each service 208, 212 built in).

The social network in various embodiments of the present invention may have a plurality of users 216, wherein A, B, . . . N are the individual users and where N may represent a relatively small overall number of users such as, for example, 20 users, or, on the other hand, N may represent a relatively large number of users such as, for example, 10,000 users or more. The social networking service 212 may maintain a social network of the plurality of users, including pertinent information about each user 216 such as, for example, contact information, the identities of each user's friends who partake in similar activities such as running, historical information about the activity that each user partakes in (e.g., the date and time of each run). Thus, the social networking service 212 may be provided by a content provider and may comprise a database of user information, while the social running service 208 may comprise an application (or “app”) that may be downloaded for free or for a fee by a user to his/her wearable device (e.g., a smartphone).

In embodiments of the present invention, the social network 204 may be dedicated to a certain type of physical activity such as running. In exemplary embodiments, the social network 204 may be capable of functioning with various different types of activities such as, for example, running. Within the social network 204, each user 216 may be required to identify various one or more friends that may all enjoy participating in the same type of activity, e.g., running and/or even different activities. Further, each user may be required to identify the level of friendship that each user has with the identified friends (e.g., a “small hop” or “short hop” means a good friend, while a relatively “large hop” means a casual acquaintance and not a good friend.)

In embodiments of the present invention, the wearable device 220 may comprise a smartphone, smart watch, smart glasses, heart monitor, or other similar type of device capable of being worn or carried by a person (i.e., in general a “wearable device”). The wearable device 220 may determine the current movement state of the person wearing the device. The movement state of the person wearing the device 220 may be, for example, stationary or otherwise moving such as, for example and without limitation, running, walking, riding a bicycle, snowboarding, surfing, swimming, etc. Embodiments described and illustrated herein are based on the context of running, but any of the other types of activities mentioned hereinabove (and also others not mentioned above) may be utilized with embodiments of the present invention in light of the teachings herein. Even embodiments that involve different users 216 performing different activities (e.g., running, walking) are contemplated by the present invention.

The wearable device 220 may also be capable of both sending and receiving communications to/from other parts of the system 200 (e.g., to/from the social running service 208 and/or the social networking service 212). As such, the wearable device 220 may have cellular capability or some other type of communication capability now known or hereafter created. In the alternative, if the wearable device 220 does not have communication capability (e.g., a watch), then the user 216 may need to utilize another device such as a cellular smartphone at the same time. In this example, the watch may communicate only with the smartphone, and the smartphone can then communicate with other devices, such as the social running service 208 and/or the social networking service 212.

In embodiments of the present invention, a certain type of movement of the user 216 may be detected by the wearable device 220. In exemplary embodiments, the type of detected human movement may be running. This type of movement may be detected by a device such as for example an accelerometer that is a part of the wearable device 220. When running of a user 216 is detected, a position locating device or system now known or hereinafter invented (e.g., a GPS system) tracks the current geographical location of the user 216 may report it in real time to the social running service 208 or may instead store it for later communication to the social running service 208.

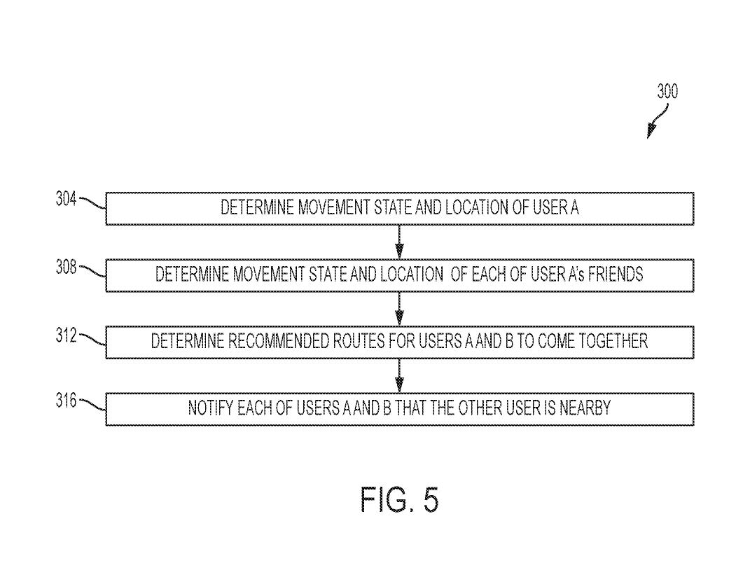

Referring to FIG. 5, a flow diagram is illustrated of a method 300 for implementing an exemplary embodiment of a social network 204 that implements the social running service 208 and the social networking service 212 in accordance with embodiments of the present invention together with an example of two users 216 (“A” and “B”) who are running at the same time and near to each other, but each user 216 does not have knowledge that the other user 216 is running at that time.

In the exemplary embodiments, as shown at block 304 the social running service 208 may determine the movement state of a user “A” 216 and the current location of user A at an instance in time for example, by using the wearable device 220 to determine that user A 216 is running. At block 308, the social running service 208 may determine the movement state of each one of user A's friends (e.g., users B, C and D) and their respective location at the same or similar instance in time. Along with user A 216, each friend of user A (i.e., users B, C and D) may also be registered with the social networking service 212 and each friend B, C and D may also have the social running service application downloaded onto the wearable device 220. For example, the social running service 208 may determine the activity of a user, A 216, and also the activity of A's friends, B, C and D 216, who are also registered as users 216 with the social running service 208.

When the social running service 208 determines that at least one of A's friends, e.g., user B 216, is also running at the same instance in time and somewhat near in location to user A (e.g., no greater than a certain predetermined distance between A and B), the social running service 208 may determine a recommended running route for each of users A and B such that their running paths would intersect at a certain geographical location at a later time. This is illustrated in block 312 in the flow diagram of FIG. 5.

The social running service 208 may determine the running route for each of user A and user B so that they come together based on various factors including, for example and without limitation: (1) the current physical distance between A and B; (2) the social distance between A and B (e.g., the number of “hops” or layers of friends, if any, between A and B); (3) the expected duration of A's run and B's run—which may be based, for example, on historical data of A's prior runs and B's prior runs, time of day data, weather data, historical data of other users who have run similar runs, etc.); (4) A or B's explicit preferences stored in the social networking service 212 for meeting any or certain ones of their friends during this run or any runs in general. If the social running service 208 decides to recommend that users A and B 216 “run into” each other or come together, then the social running service 208 may compute or determine a running route for each of A and B to cause them to intersect at a certain physical location.

In exemplary embodiments, the social running service 208 may provide the computed or determined running route to each one of the users A and B 216 by way of, for example, turn-by-turn directions of the running route for each. These such directions may be provided to the wearable device being worn or carried by A and B—for example, the smartphone, the smart watch, the smart glasses, the monitor, or other suitable device.

When users A and B 216 are nearing each other as they are heading for the common location, the social running service 208 may notify one or both runners A and/or B that the other runner is nearby, for example, by some type of alarm of by an indication of the current location of the other runner, as illustrated in block 316. Then when A and B meet up together at the common location, the social running network 208 may notify each of them 216 that they are at the correct location, or may provide some type of gamification award as part of contest being run by the overall social networking service 212 or the social running service 208.

In other embodiments of the present invention, that may be various options for how the social running service 208 handles the situation where two or more users 216 (e.g., A and B) may be travelling or running at different speeds. For example in one exemplary embodiment, running (travelling) routes may be recomputed each time user A and user B reach an intersection on a street or some other type of running path. In general, an intersection may be defined as a decision point where one user's direction may change, such as, for example, a left turn, right turn, turn around, or proceed forward. Here, each time a user (e.g., A or B) reaches an intersection, the route path for each of A and B may be recomputed to choose a new point of intersection. Thus, for example, if B is running at a different speed than A, each route for A and B may be recomputed each time B reaches a new intersection in order for B to get closer to A.

In another exemplary embodiment, the routes for each runner (e.g., A and B) may be recomputed continuously at certain time intervals (e.g., once every five seconds). This may provide a continuously updated estimate of the geographical location where A and B would intersect. Any speed differences between A and B may be factored out as the intersection point is continuously being recomputed.

In other embodiments of the present invention, both A and B may be encouraged to meet up as soon as possible, such that in real time, for example, as user A increases his/her running speed, user B may be able to see A's progress, and be told by the social running service to speed up or slow down his/her running speed so as to improve the speed at which both A and B arrive at the common location. This is a type of “gamification” technique which helps both runners A and B improve their conditioning.

In still other embodiments of the present invention, the social running service 208 may make recommendations based on the skill level and/or ability of an individual user so as to improve their conditioning. This is based on the fact that people tend to improve their skill level or ability when they join one or more people who are better at a certain activity than they are. In yet other embodiments of the present invention, the social running service may match not only friends together in an activity such as running, but may also match people who are not yet friends (i.e., strangers) so as to increase the number of candidates of higher-skilled users.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method comprising:
determining a movement state and a location of a first user, the movement state and the location of the first user being determined by a processor located within a wearable device located on the first user;
determining a movement state and a location of at least one other user, the movement state and the location of the at least one other user being determined by a processor located within a wearable device located on the at least one other user; and
providing a social network that includes a processor and a database, the social network processor being in communication with the processor of the first user wearable device and in communication with the processor of the at least one other user wearable device, wherein based on the location of the first user and the location of the at least one other user being within a predetermined distance from one another, the social network processor being configured for determining a route for each of the first user and the at least one other user to travel to come together at a single geographic location, and for communicating the determined route to each of the processor of the first user wearable device and the processor of the at least one other user wearable device.

2. The method of claim 1 wherein the movement state of the first user and the at least one other user is a running state.

3. The method of claim 1 wherein the movement state of the first user is different from the movement state of the at least one other user.

4. The method of claim 1 wherein the movement state of the first user is the same as the movement state of the at least one other user.

5. The method of claim 1 wherein based on the location of the first user and the location of the at least one other user being within a predetermined distance from one another, the social network processor being configured for determining a route for each of the first user and the at least one other user to travel to come together at a single geographic location further includes the social network processor being configured for notifying the first user and/or the at least one other user that the first user and the at least one other user are near to each other geographically.

6. The method of claim 1 wherein based on the location of the first user and the location of the at least one other user being within a predetermined distance from one another, the social network processor being configured for determining a route for each of the first user and the at least one other user to travel to come together at a single geographic location further includes the social network processor being configured for determining the route for each of the first user and the at least one other user using a current physical distance between the first user and the at least one other user.

7. The method of claim 1 wherein based on the location of the first user and the location of the at least one other user being within a predetermined distance from one another, the social network processor being configured for determining a route for each of the first user and the at least one other user to travel to come together at a single geographic location further includes the social network processor being configured for notifying the first user and the at least one other user using directions to enable the first user and the at least one other user to come together at the single geographic location.

8. A system comprising:
a social network processor in communication with one or more types of memory, the memory including a database;
a wearable device located on a first user and having a processor configured to determine a movement state and a location of the first user;
a wearable device located on at least one other user and having a processor configured to determine a movement state and a location of the at least one other user; and
the social network processor being in communication with the processor of the first user wearable device and in communication with the processor of the at least one other user wearable device, wherein based on the location of the first user and the location of the at least one other user being within a predetermined distance from one another, the social network processor being configured to determine a route for each of the first user and the at least one other user to travel to come together at a single geographic location, and to communicate the determined route to each of the processor of the first user wearable device and the processor of the at least one other wearable device.

9. The system of claim 8 wherein the movement state of the first user and the at least one other user is a running state.

10. The system of claim 8 wherein the movement state of the first user is different from the movement state of the at least one other user.

11. The system of claim 8 wherein the movement state of the first user is the same as the movement state of the at least one other user.

12. The system of claim 8 wherein based on the location of the first user and the location of the at least one other user being within a predetermined distance from one another, the social network processor being configured to determine a route for each of the first user and the at least one other user to travel to come together at a single geographic location further includes the social network processor being configured to notify the first user and/or the at least one other user that the first user and the at least one other user are near to each other geographically.

13. The system of claim 8 wherein based on the location of the first user and the location of the at least one other user being within a predetermined distance from one another, the social network processor being configured to determine a route for each of the first user and the at least one other user to travel to come together at a single geographic location further includes the social network processor being configured to determine the route for each of the first user and the at least one other user using a current physical distance between the first user and the at least one other user.

14. The system of claim 8 wherein based on the location of the first user and the location of the at least one other user being within a predetermined distance from one another, the social network processor being configured to determine a route for each of the first user and the at least one other user to travel to come together at a single geographic location further includes the social network processor being configured to notify the first user and the at least one other user using directions to enable the first user and the at least one other user to come together at the single geography location.

15. A computer program product comprising:
a non-transitory storage medium readable by a social network processing circuit and storing instructions for execution by the social network processing circuit for performing a method comprising:
determining a movement state and a location of a first user, the movement state and the location of the first user being determined by a processor located within a wearable device located on the first user;
determining a movement state and a location of at least one other user, the movement state and the location of the at least one other user being determined by a processor located within a wearable device located on the at least one other user; and
the social network processing circuit being in communication with the processor of the first user wearable device and in communication with the processor of the at least one other user wearable device, wherein based on the location of the first user and the location of the at least one other user being within a predetermined distance from one another, the social network processing circuit being configured for determining a route for each of the first user and the at least one other user to travel to come together at a single geographic location, and for communicating the determined route to each of the processor of the first user wearable device and the processor of the at least one other user wearable device.

16. The computer program product of claim 15 wherein the movement state of the first user and the at least one other user is a running state.

17. The computer program product of claim 15 wherein the movement state of the first user is different from the movement state of the at least one other user.

18. The computer program product of claim 15 wherein the movement state of the first user is the same as the movement state of the at least one other user.

19. The computer program product of claim 15 wherein based on the location of the first user and the location of the at least one other user being within a predetermined distance from one another, the social network processing circuit being configured for determining a route for each of the first user and the at least one other user to travel to come together at a single geographic location further includes the social network processing circuit being configured for notifying the first user and/or the at least one other user that the first user and the at least one other user are near to each other geographically.

20. The computer program product of claim 15 wherein based on the location of the first user and the location of the at least one other user being within a predetermined distance from one another, the social network processing circuit being configured for determining a route for each of the first user and the at least one other user to travel to come together at a single geographic location further includes the social network processing circuit being configured for determining the route for each of the first user and the at least one other user using a current physical distance between the first user and the at least one other user.
